(19) United States
(12) Patent Application Publication
(10) Pub. No.: US 2011/0062096 A1
(43) Pub. Date: Mar. 17, 2011

(54) SLIDING PRODUCT REDUCER ASSEMBLY

(76) Inventor: Robert P. Sparkowski, Schaumburg, IL (US)

(21) Appl. No.: 12/684,288

(22) Filed: Jan. 8, 2010

Related U.S. Application Data
(60) Provisional application No. 61/242,560, filed on Sep. 15, 2009.

(51) Int. Cl. A47F 1/00; A47F 7/00; G09F 3/00

(52) U.S. Cl. 211/59.3; 211/59.2; 40/299.01

(57) ABSTRACT

An improved product storage assembly attachable to a shelving assembly. The product display assembly including a base defining a support surface, and a backstop adjustable relative to the base. The backstop includes a first portion coupleable to the base, and a second portion extending generally upwardly from the first portion to display indicia creating the illusion of a fully stocked shelf.

### CROSS-REFERENCE TO RELATED APPLICATION

This application claims the benefit of and priority to U.S. Provisional Patent Application No. 61/242,560 filed Sep. 15, 2009, the entire contents of which are hereby incorporated by reference.

### FIELD OF THE INVENTION

The present invention relates to a shelving unit accessory, and more specifically to a shelving unit accessory with adjustable storage area.

### BACKGROUND

A retail display desirably provides prominent and aesthetically pleasing display of and easy access to a product. When attempting to market a product, the seller typically wants consumers to easily recognize and remove the product from the display. Merchandise can be most easily recognized and accessed if located in an upright position maintained in close proximity to the forward edge of the merchandise shelf. It is also desirable for the display to be adaptable to changes in merchandise or packaging size. Furthermore, in order to increase the overall aesthetics of the product and display, retailers often prefer the appearance of fully stocked shelves.

### SUMMARY

In some embodiments, the present invention provides a product display assembly for placement on a shelving unit to display merchandise, and the product display assembly includes a base defining a support surface and a backstop adjustable relative to the base. The backstop includes a first portion coupleable to the base, a second portion extending generally upwardly from the first portion, and indicia displayed on the second portion.

In another embodiment, the invention provides a product display assembly for placement on a shelving unit to display merchandise, and the product display assembly includes a base having a support surface and a backstop adjustably coupled to the base and moveable between an increased inventory position and a decreased inventory position. The backstop includes a first portion and a second portion extending generally upwardly from the first portion, where the second portion is substantially adjacent to the base when the backstop is in the decreased inventory position and spaced from the base when the backstop is in the increased inventory position. The product display assembly also includes indicia displayed on the second portion.

In another embodiment, the invention provides a product display assembly for placement on a shelving unit to display merchandise, and the product display assembly includes: a base having a first support surface, a forward base edge, a rearward base edge opposite the forward base edge, and a pair of side base edges extending between the forward and rearward base edges. The base defines a first plurality of openings positioned substantially adjacent the forward base edge and a second plurality of openings. The product display assembly also includes a backstop movable relative to the base, the backstop including a generally horizontal portion and a generally vertical portion extending upwardly from the generally horizontal portion, the generally horizontal portion having a forward backstop edge, a rearward backstop edge opposite the forward backstop edge, a pair of side backstop edges extending between the forward and rearward backstop edges, and slots extending substantially perpendicular the forward backstop edge. The generally horizontal portion defines a second support surface. The product display also includes indicia displayed on the vertical portion of the backstop and a pair of fasteners, each fastener extending through a respective one of the second plurality of openings and into a respective one of the slots for guiding movement of the backstop relative to the base. The backstop is linearly movable with respect to the base between a decreased inventory position where the generally vertical portion is substantially adjacent the rearward base edge and an increased inventory position where the vertical portion is spaced at an increased distance from the rearward base edge.

### BRIEF DESCRIPTION OF THE DRAWINGS

FIG. 1 is a front perspective view of a product display assembly.

FIG. 2 is an exploded view of the product display assembly of FIG. 1.

FIG. 3 is a front perspective view of a first product display assembly in an increased inventory position, and a second product display assembly in a reduced inventory position.

FIG. 4 is a front perspective view of the product display assembly of FIG. 1 positioned on a shelving unit.

It is to be understood that the invention is not limited in its application to the details of construction and the arrangements of the components set forth in the following description or illustrated in the drawings. The invention is capable of other embodiments and of being practiced or being carried out in various ways. Also, it is to be understood that the phraseology and terminology used herein is for the purpose of description and should not be regarded as limiting.

### DETAILED DESCRIPTION

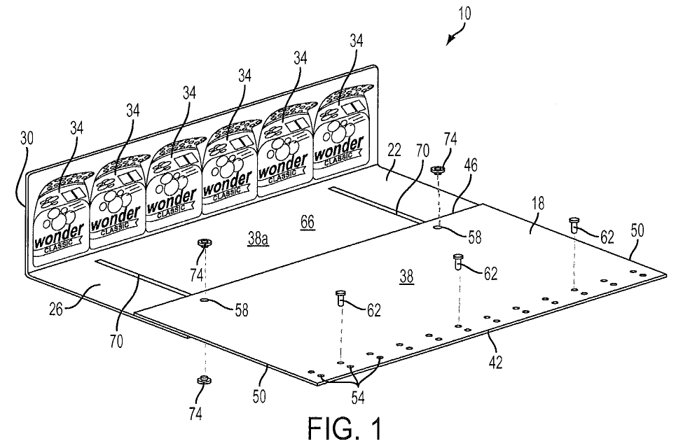

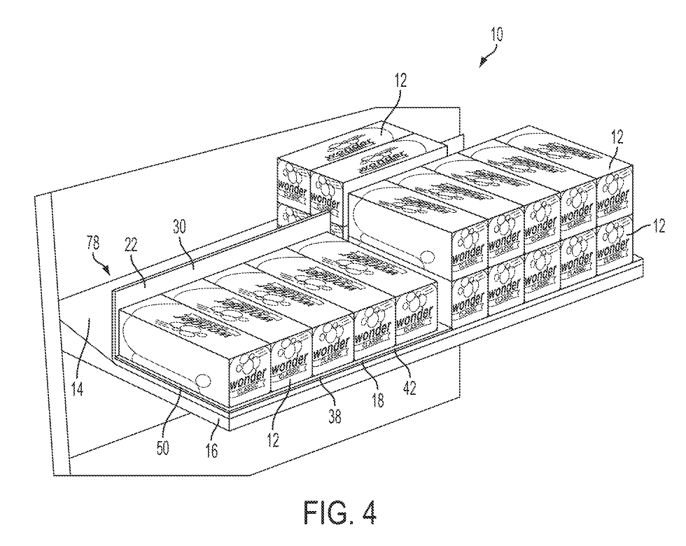

FIGS. 1-4 illustrate a product display assembly 10 attachable to a support structure or shelving unit 14 to display merchandise 15 (see FIG. 4) for example, in a retail outlet or supermarket. The product display assembly 10 includes a base 18 and a backstop 22 adjustably coupled to the base 18. The backstop 22 includes a first substantially horizontal portion 26 coupled to the base 18, and a second substantially vertical portion 30. Indicia 34 can be displayed in front of vertical portion 30 and above the second portion 26 of the backstop 22. As discussed below, the product display assembly 10 can be adjusted depending upon the amount of merchandise it holds. By replicating the appearance of the merchandise on assembly 10, the indicia 34 cooperates with the backstop 22 to provide the appearance of a full supply of merchandise even as merchandise is removed from the display assembly 10.

The base 18 of the product display assembly 10 is generally rectangular and includes a support surface 38 for placing merchandise 12 (see FIG. 4), a front edge 42, a rear edge 46 opposite the front edge 42, and a pair of side edges 50 extending between the front and rear edges 42, 46. The base 18 also includes a first plurality of apertures 54 proximate the front edge 42 for coupling the base 18 to a corresponding shelf 16 (see FIG. 4), and a second plurality of apertures 58 for adjustably coupling the base 18 and the backstop 22.

In the illustrated embodiment, the base 18 is substantially planar and formed of a suitable sheet material (e.g., steel), however in some constructions, the support surface 38 may be contoured to include grooves, channels, ridges, recesses, uprights, and the like, which may better support and/or stabilize certain types of merchandise that may be placed on the assembly 10. In other constructions, the base 18 may have a unique contour to better correspond to the shape and/or size of the shelf 16 to which the assembly 10 is coupled. In yet other alternate constructions, the side edges 50 may include a plurality of tabs, recesses, hooks and the like corresponding to similar elements of adjacent product display assemblies to properly position, join, or secure each product display assembly 10 with respect to adjacent product display assemblies. In yet another construction, the front edge 42 of the base 18 may include signage (not shown) or suitable support features for such signage to display the name, price, or other information regarding the merchandise to be sold. In still other constructions, the base 18 may include recesses, hooks, or other mounting provisions for maintaining fencing, rails, signage, and the like to better support, separate, advertise, or maintain the merchandise 12.

The first plurality of apertures 54 are generally positioned proximate the front edge 42 of the base 18 to receive a fastener, such as a pine tree clip 62, to couple the base 18 with the shelf 16. In some alternate constructions, one or more apertures of the first plurality of apertures 54 may be elongated or oversized to allow the base 18 to be adjusted with respect to the shelf 16. In still other constructions, the base 18 may include protrusions (not shown) extending from the bottom of the base 18, configured to be received by a corresponding aperture in the shelf 16. In still other constructions, the base 18 may include magnets, rubber pads, hooks, double stick tape and the like to limit movement of or otherwise secure the base 18 relative to the shelf 16.

Each of the second plurality of apertures 58 is positioned to correspond to a respective slot 70 (described below) to adjustably couple the base 18 and the backstop 22. In the illustrated embodiment, each aperture is shaped to receive at least a portion of a fastener or plastic button clip 74. In some constructions, one or more of the apertures 58 may be elongated or oversized to allow additional degrees of freedom between the base 18 and the backstop 22.

The first portion 26 of the backstop 22 includes an upper surface 66 and defines at least one and preferably a plurality of elongated slots 70 of preferably equal length. The elongated slots 70 extend generally perpendicular to the second portion 30 and are configured to receive at least a portion of the plastic button clip 74 that extends through a corresponding one of the second plurality of apertures 58. In the illustrated embodiment, each slot 70 is also configured to permit the backstop 22 to slide relative to the plastic button clip 74 along at least a portion of the length of the slots 70.

In some constructions, the backstop 22 may include a plurality of side walls (not shown) extending generally perpendicular to both the second portion 30 and the first portion 26. In other constructions, the backstop 22 may include grooves, channels, ridges, recesses, uprights, and the like that correspond to features that may also be present on the base 18. In yet other constructions, each slot 70 may include indicia or a plurality of distinct recesses positioned a measured distance from one another to provide multiple pre-determined positions for the backstop 22.

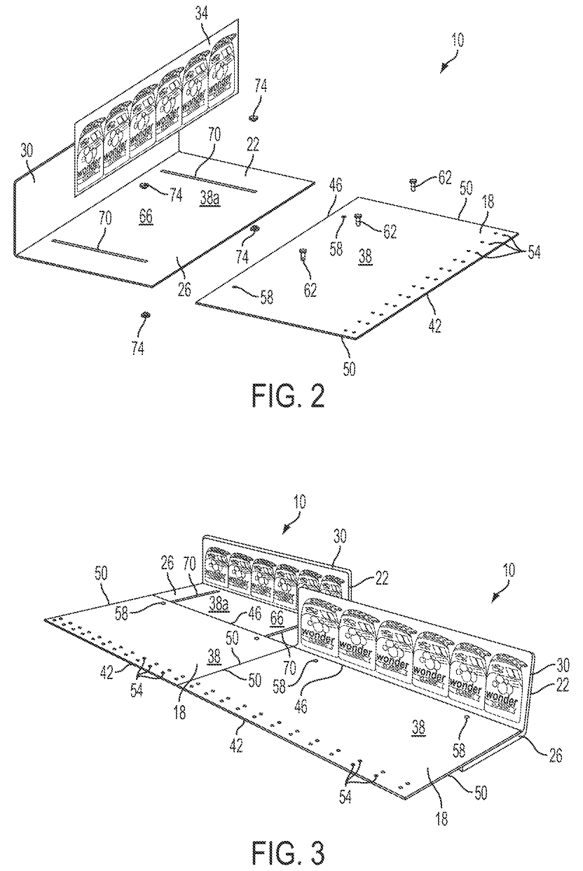

As shown in FIG. 2, the backstop 22 is adjustably coupled to the base 18 for movement between an increased inventory position and a decreased inventory position. When the backstop 22 is in the increased inventory position, the second portion 30 is spaced rearwardly from the rear edge 46 of the base 18. When the backstop 22 is in the decreased inventory position, the second portion 30 is generally adjacent the rear edge 46 of the base 18. The configuration of the slot 70 also allows the backstop 22 to be moved to a variety of intermediate positions between the increased and decreased inventory positions. The upper surface 66 of backstop 22 also provides a supplemental support surface 38a when the backstop 22 is at least partially moved away from base 18.

In the illustrated construction, the base 18 and the backstop 22 are adjustably coupled by way of fasteners, however in other constructions; the base 18 may include a channel able to accept at least a portion of the backstop 22. In yet another construction, the backstop 22 may be adjustably coupled directly to the shelf 16. In still other constructions, each base 18 may correspond to multiple backstops 22, each backstop 22 able to be adjusted independently of one another.

As seen in FIG. 4, when the product display assembly 10 is placed on a shelf 16, it may produce a storage volume 78 behind the backstop 22 that is suitable for storing excess merchandise. When this occurs, the backstop 22 not only provides a rear boundary for the merchandise being displayed, but also at least partially shields the excess merchandise from view of the purchaser. In this regard, merchandise stored behind the backstop 22 can be arranged differently than merchandise in front of the second portion 30, thereby maximizing the usefulness of the storage volume 78 while allowing merchandise in front of the second portion 30 to be positioned for easy removal by the customer. The backstop 22 can thus be adjusted not only to accommodate the size and quantity of the merchandise being displayed, but can be altered to adjust the amount of storage space available in storage volume 78.

Best illustrated in FIGS. 1-3, the indicia 34 generally displays an image of the merchandise positioned within the product display assembly 10 and cooperates with the backstop 22 to provide the appearance that the shelf 16 is fully stocked. In some constructions, the indicia 34 may be printed directly on the backstop 22. In other constructions, the indicia 34 may be removably coupled to the second portion 30 of the backstop 22 to display images of the product, advertisements, text, and the like. For example, the indicia 34 may include a removable vinyl sticker or magnet with an image printed on the surface so the indicia 34 may be changed with the merchandise being displayed in the assembly 10. In some constructions, the product display assembly 10 may include multiple indicia 34, and each indicia 34 may be independently removable from the backstop 22 to correspond to various products or items placed on the assembly 10.

What is claimed is:

1. A product display assembly for placement on a shelving unit to display merchandise, the product display assembly comprising:
a base defining a support surface; and
a backstop adjustable relative to the base, the backstop including a first portion coupleable to the base, and a second portion extending generally upwardly from the first portion.

2. The product display assembly of claim 1, further comprising indicia displayed on the second portion of the backstop.

3. The product display assembly of claim 2, wherein the indicia is printed directly on the backstop.

4. The product display assembly of claim 3, wherein the indicia includes an image of the merchandise.

5. The product display assembly of claim 1, wherein the backstop is adjustable between an increased inventory position and a reduced inventory position.

6. The product display assembly of claim 5, wherein the second portion is proximate the base in the decreased inventory position and spaced from the base in the increased inventory position.

7. The product display of claim 5, wherein the first portion of the backstop defines at least one slot and the base defines at least one opening, wherein the backstop is adjustably coupled to the base by at least one fastener, the at least one fastener extending through the at least one opening and into the at least one slot.

8. The product display assembly of claim 2, wherein the second portion and the indicia cooperate to provide the appearance of an at least partially stocked shelf.

9. The product display of claim 1, wherein the base includes a forward edge and openings extending along the forward edge, the openings configured to receive a fastener for coupling the base to the shelving unit.

10. The product display of claim 1, wherein the second portion separates the support surface from a storage area.

11. A product display assembly for placement on a shelving unit to display merchandise, the product display assembly comprising:
a base having a first support surface; and
a backstop adjustably coupled to the base and moveable between an increased inventory position and a decreased inventory position, the backstop including a first portion and a second portion extending generally upwardly from the first portion, the second portion substantially adjacent to the base when the backstop is in the decreased inventory position and spaced from the base when the backstop is in the increased inventory position.

12. The product display assembly of claim 11, further comprising indicia displayed on the second portion.

13. The product display assembly of claim 11, wherein the second portion includes an upper surface, and wherein more of the upper surface is exposed when the backstop is in the increased inventory position than when the backstop is in the decreased inventory position.

14. The product display assembly of claim 12, wherein the indicia includes an image of the merchandise.

15. The product display of claim 11, wherein the first portion of the backstop defines at least one slot and the base defines at least one opening, wherein the backstop is adjustably coupled to the base by at least one fastener, the at least one fastener extending through the at least one opening and into the at least one slot.

16. The product display of claim 11, wherein the second portion and the shelving unit defines a storage area.

17. A product display assembly for placement on a shelving unit to display merchandise, the product display assembly comprising:
a base having a first support surface, a forward base edge, a rearward base edge opposite the forward base edge, and a pair of side base edges extending between the forward and rearward base edges, the base defining at least one opening positioned substantially adjacent the forward base edge and at least one opening remote from the forward base edge;
a backstop movable relative to the base, the backstop including a generally horizontal portion and a generally vertical portion extending upwardly from the generally horizontal portion, the generally horizontal portion having a forward backstop edge, a rearward backstop edge opposite the forward backstop edge, a pair of side backstop edges extending between the forward and rearward backstop edges, and at least one slot extending substantially perpendicular the forward backstop edge, the generally horizontal portion defining a second support surface;
indicia displayed on the generally vertical portion; and
at least one fastener, the at least one fastener extending through the at least one opening remote from the forward edge and into the at least one slot,
wherein the backstop is linearly movable with respect to the base between a decreased inventory position where the generally vertical portion is closer to the rearward base edge than when the backstop is in an increased inventory position.

18. The product display assembly of claim 17, wherein the indicia includes an image of the merchandise and provides the appearance of an at least partially stocked shelf when the backstop is in the decreased inventory position.
